(19) United States
(12) Patent Application Publication
(10) Pub. No.: US 2013/0084353 A1
(43) Pub. Date: Apr. 4, 2013

(54) STAMP FOR MOLDING LENSES

(71) Applicants: Jin Uk LEE, Suwon (KR); Cheong Hee Lee, Gyunggi-do (KR); Young Su Jin, Suwon (KR); Seok Cheon Lee, Suwon (KR)

(72) Inventors: Jin Uk LEE, Suwon (KR); Cheong Hee Lee, Gyunggi-do (KR); Young Su Jin, Suwon (KR); Seok Cheon Lee, Suwon (KR)

(73) Assignee: SAMSUNG ELECTRO-MECHANICS CO., LTD., Suwon (KR)

(21) Appl. No.: 13/609,550

(22) Filed: Sep. 11, 2012

(30) Foreign Application Priority Data
Sep. 29, 2011 (KR) 10-2011-0098958

(51) Int. Cl. B29C 43/04

(52) U.S. Cl. 425/408

(57) ABSTRACT

There is provided a stamp for molding lenses, including: a first stamp including a plurality of first lens molding parts; and a second stamp including a plurality of second lens molding parts corresponding to the plurality of first lens molding parts, wherein the first lens molding parts have different sizes so as to mold at least two types of lens.

### CROSS-REFERENCE TO RELATED APPLICATIONS

This application claims the priority of Korean Patent Application No. 10-2011-0098958 filed on Sep. 29, 2011, in the Korean Intellectual Property Office, the disclosure of which is incorporated herein by reference.

### BACKGROUND OF THE INVENTION

1. Field of the Invention

The present invention relates to a stamp for molding lenses, and more particularly, to a stamp for molding lenses able to simultaneously mold different types of lens.

2. Description of the Related Art

As demand for high-resolution camera modules has increased, demand for a high-resolution lens module in which a plurality of lenses are stacked has correspondingly increased.

A high-resolution lens module may be manufactured by vertically stacking and bonding a plurality of lenses.

For example, a high-resolution lens module configured of four lenses is completed by manufacturing stamps for molding lenses corresponding to respective lenses among the four lenses, manufacturing respective lenses (that is, a first lens, a second lens, a third lens, and a fourth lens) using the stamps for molding lenses, and stacking the manufactured lenses in order.

However, in the above-detailed manufacturing method, the plurality of stamps for manufacturing respective lenses configuring the lens module are required to be manufactured, such a process may disadvantageously consume an excessive amount of costs and time in manufacturing a kind of lens module.

### SUMMARY OF THE INVENTION

An aspect of the present invention provides a stamp for molding lenses able to simultaneously mold at least two types of lens so as to easily manufacture a high-resolution lens module.

According to an aspect of the present invention, there is provided a stamp for molding lenses, including: a first stamp including a plurality of first lens molding parts; and a second stamp including a plurality of second lens molding parts corresponding to the plurality of first lens molding parts, wherein the first lens molding parts have different sizes so as to mold at least two types of lens.

The first lens molding part may be planar, spherical or aspherical.

The second lens molding part may be planar, spherical or aspherical.

The first lens molding part may include a primary first lens molding part molding a first lens module and a secondary first lens molding part molding a second lens module other than the first lens module, and the first stamp may include a first area in which the primary first lens molding part is formed and a second area in which the secondary first lens molding part is formed.

The first area and the second area may be symmetrically formed with regard to each other, based on a bisector of the first stamp.

The second area may be formed in an edge area of the first stamp.

The first area and the second area may be alternately formed in the first stamp.

The first lens molding parts may have gradually reduced sizes from a center of the first stamp toward an edge thereof.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are plan views of a stamp for molding lenses according to a first embodiment of the present invention;

FIG. 3 is a cross-sectional view illustrating a lens molding state using a first stamp and a second stamp shown in FIGS. 1 and 2;

FIG. 4 is a plan view of a stamp for molding lenses according to a second embodiment of the present invention;

FIG. 5 is a plan view of a stamp for molding lenses according to a third embodiment of the present invention; and

FIG. 6 is a plan view of a stamp for molding lenses according to a fourth embodiment of the present invention.

### DETAILED DESCRIPTION OF THE EMBODIMENTS

Hereinafter, exemplary embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

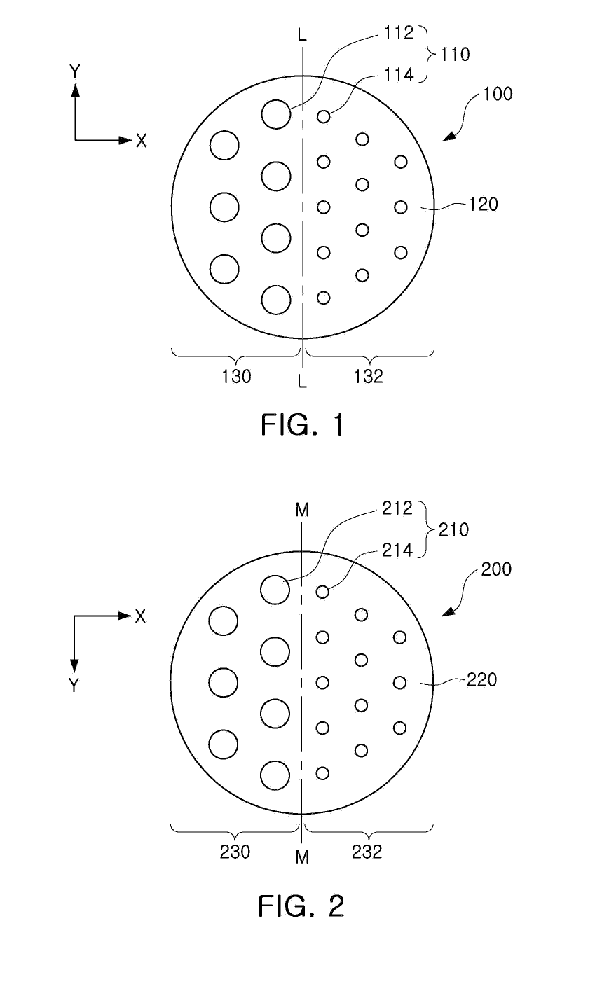

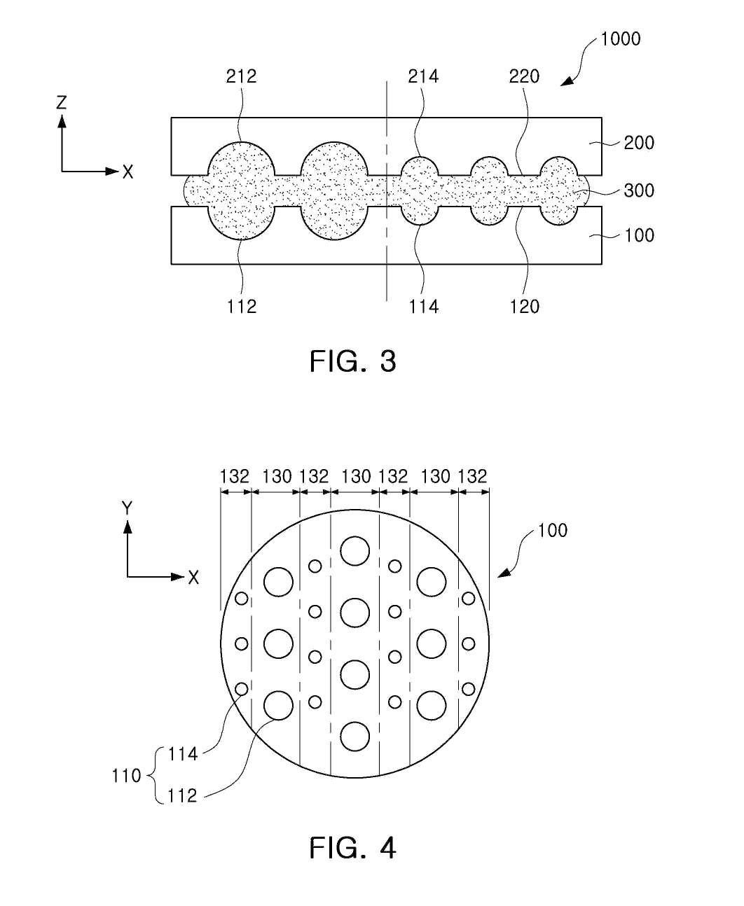

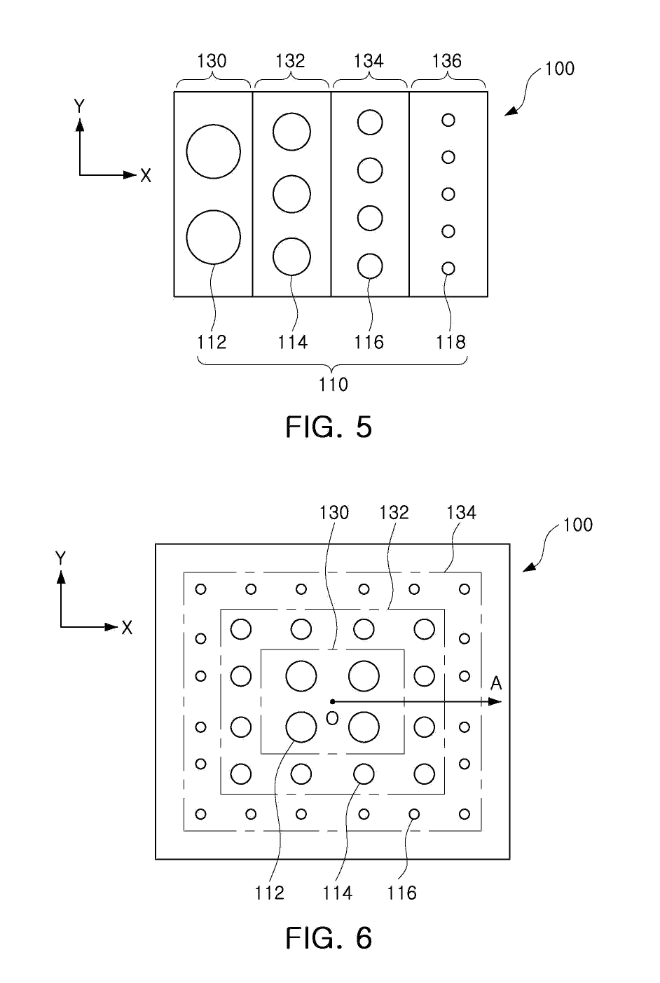

FIGS. 1 and 2 are plan views of a stamp for molding lenses according to a first embodiment of the present invention, FIG. 3 is a cross-sectional view illustrating a lens molding state using a first stamp and a second stamp shown in FIGS. 1 and 2, FIG. 4 is a plan view of a stamp for molding lenses according to a second embodiment of the present invention, FIG. 5 is a plan view of a stamp for molding lenses according to a third embodiment of the present invention, and FIG. 6 is a plan view of a stamp for molding lenses according to a fourth embodiment of the present invention.

First, a stamp for molding lenses according to the first embodiment of the present invention will be described with reference to FIGS. 1 to 3. For reference, FIG. 1 is a plan view of a first stamp and FIG. 2 is a bottom view of a second stamp.

A stamp 1000 for molding lenses according to the first embodiment of the present invention may include a first stamp 100 and a second stamp 200.

The first stamp 100 may be disposed in a lower position during lens molding and may be a fixed mold that does not move. On the contrary, the second stamp 200 may be disposed in an upper position during lens molding and may be a movable mold that may be moved toward the first stamp 100 for compression. However, stamp positions and a stamping operation as described above may be changed according to types and characteristics of lenses to be manufactured and a working environment.

The first stamp 100 may be formed of plastic. In more detail, the first stamp 100 may be formed of a transparent resin material so as to allow light (for example, ultraviolet rays) that can harden a lens material to be transmitted therethrough. However, the first stamp 100 is not limited thereto and may be formed of glass or other materials.

The first stamp 100 may include a first lens molding part 110 and a first flat part 120.

The first lens molding part 110 may mold a first surface of a lens and may mold a lens surface to have a convex shape, a concave shape, a spherical shape or an aspherical shape. In addition, the first lens molding part 110 may include a primary first lens molding part 112 and a secondary first lens molding part 114. In this configuration, the primary first lens molding part 112 and the secondary first lens molding part 114 may individually mold one surfaces of lenses having different optical characteristics. For example, the primary first lens molding part 112 and the secondary first lens molding part 114 may mold different types of lens surfaces having different refractive indexes, Abbe values, focal distances, or refractive powers.

Meanwhile, the first stamp 100 may be differentiated into first and second areas 130 and 132 in which the primary first lens molding part 112 and the secondary first lens molding part 114 are formed, based on a segment L-L. Here, the first area 130 may be provided with the primary first lens molding part 112 and the second area 132 may be provided with the secondary first lens molding part 114.

For reference, FIG. 1 shows that the number of lens molding parts 112 and 114 formed in the first area 130 and the second area 132 is different, but may be the same or arbitrarily changed, if necessary.

The first flat part 120 may indicate the remaining parts of the first stamp 100, other than the first lens molding part 110. The first flat part 120 may mold a flange part for the lens module having the lens surface.

The second stamp 200 may include a second lens molding part 210 and a second flat part 220.

The second lens molding part 210 may mold a second surface of a lens and may mold a lens surface to have a convex shape, a concave shape, a spherical shape or an aspherical shape. In addition, the second lens molding part 210 may include a primary second lens molding part 212 and a secondary second lens molding part 214. In this configuration, the primary second lens molding part 212 and the secondary second lens molding part 114 may individually mold one surfaces of lenses having different optical characteristics. For example, the primary second lens molding part 212 and the secondary second lens molding part 214 may mold different types of lens surfaces having different refractive indexes, Abbe values, focal distances, or refractive powers. However, when the first lens molding part 110 (112 and 114) mold lens surfaces having different optical characteristics, the second lens molding part 210 (212 and 214) may mold lens surfaces having the same optical characteristics. For example, the second lens molding part 210 may mold the lens surface having the same refractive index, Abbe value, or focal distance and may also have a planar shape.

The second flat part 220 may indicate the remaining parts of the second stamp 200, other than the second lens molding part 210. The second flat part 220 may mold a flange part for the lens module having the lens surface.

Meanwhile, the second stamp 200 may be differentiated into third and fourth areas 230 and 232 in which the primary second lens molding part 212 and the secondary second lens molding part 214 are formed, based on a segment M-M. Here, the third area 230 may be provided with the primary second lens molding part 212 and the fourth area 232 may be provided with the secondary second molding part 214.

For reference, in FIG. 2, the number of lens molding parts 212 and 214 formed in the third area 230 and the fourth area 232 of the second stamp 200 may be equal to the number of lens molding parts 112 and 114 formed in the first area 130 and the second area 132 of the first stamp 100.

As such, the first stamp 100 and the second stamp 200 are vertically disposed having a lens material 300 interposed therebetween as shown in FIG. 3, and a lens module or a lens array may be molded by compressing the lens material 300.

The lens molding stamp 1000 configured as described above may mold different types of lens in a one-time compression process. Therefore, according to the embodiment of the present invention, the number of stamps required to mold various types of lens may be reduced and lens manufacturing costs may be reduced accordingly.

Hereinafter, other embodiments of the present invention will be described. For reference, only the first stamp 100 will be described and shown below, but it will be apparent to those skilled in the art that the second stamp 200 may be changed to have the same or a similar shape to that of the first stamp 100.

The second embodiment will be described with reference to FIG. 4.

The first stamp 100 according to the second embodiment of the present invention may have the first area 130 and the second area 132 alternately formed thereon. That is, the first area 130 and the second area 132 may be alternately formed in an X-axis direction of the first stamp 100.

Here, the first area 130 may be provided with the primary first lens molding part 112 molding a lens having a relatively large size and the second area 132 may be provided with the secondary first lens molding part 114 molding a lens having a relatively small size.

As described above, when the primary first lens molding part 112 and the secondary first lens molding part 114 mold lenses having different sizes, the first area 130 and the second area 132 may partially overlap each other. In this case, the first stamp 100 may be formed to have a relatively large number of lens molding parts.

The third embodiment will be described with reference to FIG. 5.

The first stamp 100 according to the third embodiment of the present invention may be rectangular and have at least three types of first lens molding part 110 (112, 114, 116, and 118).

That is, in the embodiment of the present invention, the first lens molding part 110 may include a primary first lens molding part 112, a secondary first lens molding part 114, a tertiary first lens molding part 116, and a quaternary first lens molding part 118. Here, the primary first lens molding part 112 may mold the lens having the largest size and the quaternary first lens molding part 118 may mold the lens having the smallest size.

A first area 130 having the primary first lens molding part 112 formed therein to a fourth area 136 having the quaternary first lens molding part 118 formed therein may be formed in order in a longitudinal direction (an X-axis direction based on FIG. 5) of the first stamp 110 as shown in FIG. 5.

In the embodiment of the present invention, the first lens molding parts 112, 114, 116, and 118 molding different lenses are sequentially formed in one direction of the first stamp 100 and therefore, each lens molding part can be easily differentiated.

A fourth embodiment will be described with reference to FIG. 6.

The first stamp 100 according to the fourth embodiment of the present invention may be differentiated from the third embodiment of the present invention in terms of the arrangement of the first lens molding parts. That is, in the first stamp 100 according to this embodiment of the present invention, the first lens molding parts 110 (112, 114, and 116) may be arranged outwardly (direction of an arrow A) from a center O of the first stamp 100.

The plurality of lens molding parts may be effectively arranged in the present embodiment, and thus, they can easily mold at least three types of lens.

As set forth above, according to embodiments of the present invention, a stamp for molding lenses can simultaneously mold at least two types of lens, thereby rapidly manufacturing high-resolution lens modules for different types of lens.

Further, the stamp according to the embodiments of the present invention can mold at least two types of lens at a time, thereby reducing manufacturing costs and time required to manufacture the high-resolution lens modules.

While the present invention has been shown and described in connection with the embodiments, it will be apparent to those skilled in the art that modifications and variations can be made without departing from the spirit and scope of the invention as defined by the appended claims.

What is claimed is:

1. A stamp for molding lenses, comprising:
a first stamp including a plurality of first lens molding parts; and
a second stamp including a plurality of second lens molding parts corresponding to the plurality of first lens molding parts,
wherein the first lens molding parts have different sizes so as to mold at least two types of lens.

2. The stamp for molding lenses of claim 1, wherein the first lens molding part is planar, spherical or aspherical.

3. The stamp for molding lenses of claim 1, wherein the second lens molding part is planar, spherical or aspherical.

4. The stamp for molding lenses of claim 1, wherein the first lens molding part includes a primary first lens molding part molding a first lens module and a secondary first lens molding part molding a second lens module other than the first lens module, and
the first stamp includes a first area in which the primary first lens molding part is formed and a second area in which the secondary first lens molding part is formed.

5. The stamp for molding lenses of claim 4, wherein the first area and the second area are symmetrically formed with regard to each other, based on a bisector of the first stamp.

6. The stamp for molding lenses of claim 4, wherein the second area is formed in an edge area of the first stamp.

7. The stamp for molding lenses of claim 4, wherein the first area and the second area are alternately formed in the first stamp.

8. The stamp for molding lenses of claim 1, wherein the first lens molding parts have gradually reduced sizes from a center of the first stamp toward an edge thereof.
